(19) United States
(12) Patent Application Publication
(10) Pub. No.: US 2007/0074199 A1
(43) Pub. Date: Mar. 29, 2007

(54) Method and apparatus for delivering microcode updates through virtual machine operations

(76) Inventor: Sebastian Schoenberg, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/237,034

(22) Filed: Sep. 27, 2005

(51) Int. Cl. G06F 9/44

(52) U.S. Cl. 717/168

(57) ABSTRACT

Instructions to change a microcode program of a virtual device are trapped and the replacement program is saved. Later, the microcode program is installed on one or more non-virtual devices. Software and systems using the method are also described.

### FIELD OF THE INVENTION

The invention relates to virtual machine monitor (“VMM”) operations. More specifically, the invention relates to dealing with microcode updates in VMM systems.

### BACKGROUND

Many contemporary computer processors use low-level routines called microcode to implement features that would be too complex or expensive to implement as ordinary hard-wired logic. Microcode can also permit processor manufacturers to correct hardware errors: a microcode subroutine can be configured to supplement, override or replace a hardware calculation or other operation. Microcode can be used to add features to processors that are already deployed in computer systems. Installing microcode on a processor is sometimes called “patching” the processor.

Other hardware devices that may be installed in a computer system may also use low-level software or configuration data to control their operation. This low-level software or data is typically called “firmware,” but is similar to microcode in several ways. A new firmware version can be used to correct or improve the operation of a device, and new firmware can often be installed on the fly, without removing the device from the system.

The term “microcode” will be used throughout this specification to refer to low-level software routines and configuration data, but it should be understood that the term encompasses software and data to be installed on computer processors (e.g., microprocessors and central processing units or “CPUs”) as well as software and data to be installed on other types of devices such as embedded processors, programmable gate arrays, digital signal processors, and similar devices.

Updated microcode to correct errors or to provide new functionality is typically installed through one of two mechanisms. First, Basic Input/Output System (“BIOS”) software that controls a computer system when it is first powered on (or after a reset operation) can install the microcode as part of the system initialization process. Second, an operating system (“OS”) started by the BIOS can install the microcode during its boot-up sequence. In either case, because new microcode can fundamentally affect the processor's or other device's operation, it is usually installed early in the initialization process to avoid erratic operation of software that inspects the system's configuration before the new microcode is installed, and that relies on a specific processor or device behavior that is changed by the new microcode.

When a new microcode version is released, it is often preferred to install it during the operating system boot-up sequence because the operating system usually provides better tools and resources to obtain and manage the microcode. Installing new microcode through the BIOS may require updating the entire BIOS, an inconvenient and sometimes perilous operation. (A failed BIOS update can render the machine inoperative.)

One recent development that affects the distribution and installation of microcode updates is the increased use of virtual machine systems. Recent computer processors provide hardware and system-control instructions that enable software running on an actual system to provide an almost-perfect emulation of a virtual system, with only a small speed penalty. Benefits of such virtual systems include, for example, the ability to run multiple operating systems on a single physical machine; improved utilization of CPU and hardware resources; and reduced development time when software is developed on a virtual system. Virtual Machine Monitors (“VMMs”) can be designed in various ways. For example, a VMM may run as an application under a traditional operating system (the “hosted model”), directly on the physical hardware (the “hypervisor model”), or as a combination that executes a small component on bare hardware but leverages a conventional operating system to support the VMM (the “hybrid approach”).

Unfortunately, the latter two VMM system types usually lack sophisticated user-interface and file-handling capabilities, so they are not well-suited to obtaining and managing microcode updates. Furthermore, several factors prevent the use of existing OS boot-up microcode loading mechanisms to install microcode from a guest OS running under a VMM into a physical (non-virtual) processor or physical (non-emulated) device, and (as mentioned previously) BIOS-based mechanisms are disfavored. Therefore, a new method of delivering microcode updates through virtual machine operations may be of substantial benefit.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 is a block diagram of an operating system-hosted virtual machine monitor.

FIG. 2 is a block diagram of a stand-alone virtual machine monitor that implements an embodiment of the invention.

FIG. 3 is a flow chart showing how a virtual machine monitor can collect and later install microcode updates.

FIG. 4 shows some of the components of an operating system-hosted virtual machine monitor in greater detail.

FIG. 5 shows some components of a physical system that could host an embodiment of the invention, contrasted with some emulated components of a virtual environment.

### DETAILED DESCRIPTION

Embodiments of the invention trap microcode installation attempts by software running in a virtual execution environment. The microcode to be installed is saved, and may be installed when the physical system is in an appropriate state to permit such installation to proceed safely.

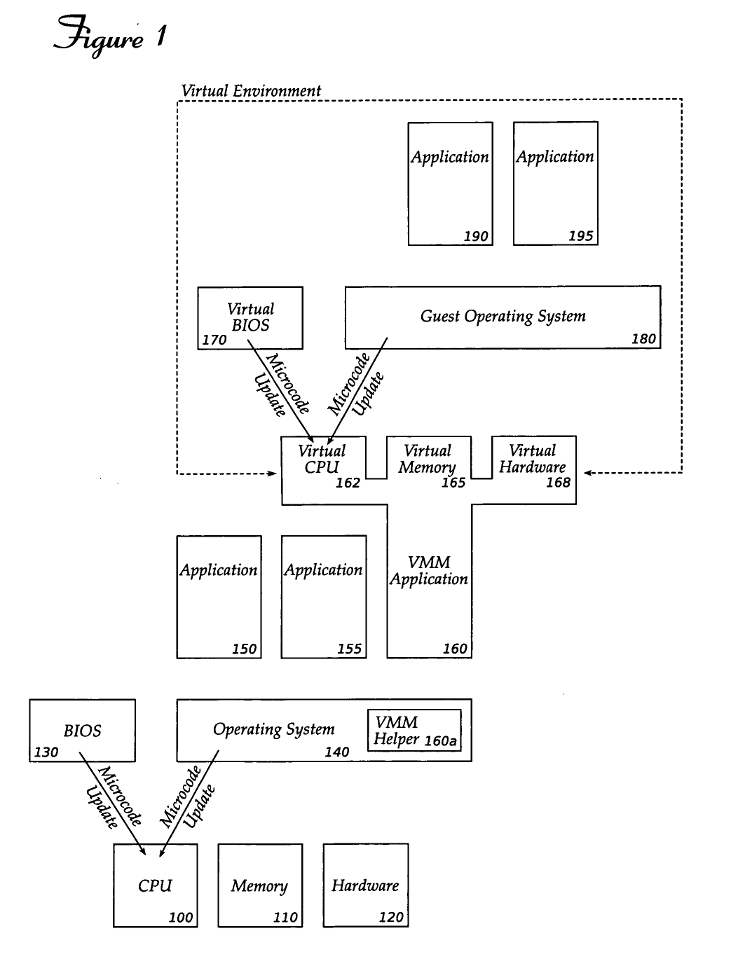

FIG. 1 illustrates some relationships between software and hardware components of a computer system. CPU 100 is a processor that can accept a new microcode version. Memory 110 stores instructions and data to be operated on by CPU 100, and hardware 120 represents the physical devices that may be installed in the system (e.g. keyboard and video controllers, mass storage controllers, and network interfaces). BIOS 130 and host operating system 140 represent software instructions that may be stored, for example, in memory 110 or in a separate, non-volatile memory (not shown). Instructions in either the BIOS 130 or the operating system 140 (or both) can install a microcode update into CPU 100.

Applications 150 and 155 represent programs that may execute under the control of host OS 140. Instructions and data for the applications may be stored in memory 110. Application 160 is a virtual machine monitor (“VMM”) that emulates a computer system; as shown, it presents an interface similar to the real system hardware to software running under its control. Specifically, VMM application 160 provides emulated (virtual) CPU 162, emulated (virtual) memory 165, and emulated (virtual) hardware 168, which are manipulated by virtual BIOS 170 and Guest OS 180. (Software running in a virtual machine environment is often called “guest” software.) Virtual BIOS 170 and/or Guest OS 180 may include instructions to install a microcode update into virtual CPU 162, but the microcode would not actually be sent to physical CPU 100 immediately. Instead, an embodiment of the invention located in the VMM application 160 or in a cooperating software module such as a device driver or kernel module, located logically in operating system 140 (shown in this figure as VMM Helper 160a) could save the microcode update for later installation. Applications 190 and 195 could execute in the virtual environment under the control of Guest OS 180.

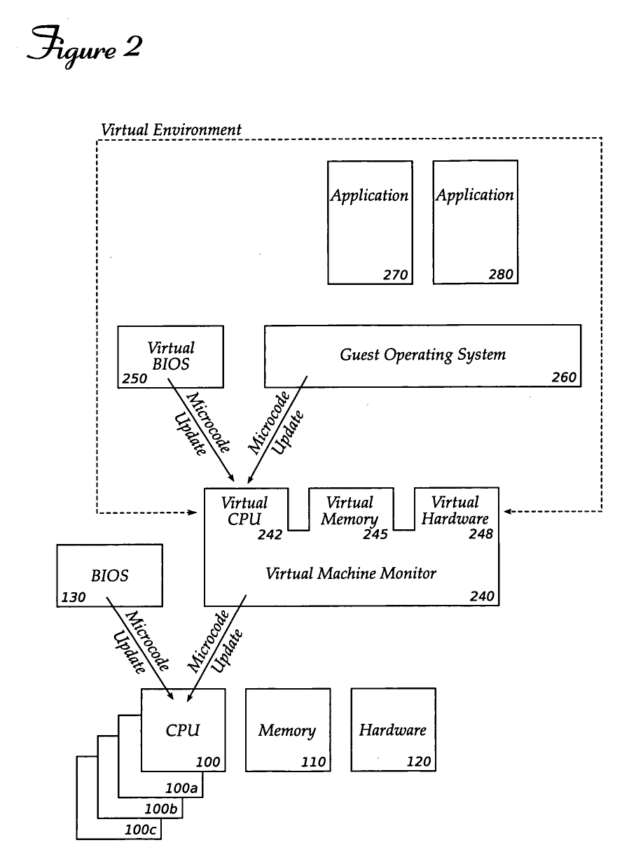

FIG. 2 illustrates relationships between software and hardware components of a computer system configured to run a stand-alone virtual machine monitor (“hypervisor”) implementing an embodiment of the invention. CPU 100, memory 110 and hardware 120 may be similar to the corresponding elements shown in FIG. 1. The physical computer system may include multiple processors, shown here as 100a, 100b and 100c. BIOS 130 may be provided to control the system during power-up and reset initialization, and may install a microcode update onto physical CPUs 100, 100a, 100b and 100c during start-up. However, VMM 240 provides a “layer” of virtualization, so that virtual BIOS 250 and Guest OS 260 interact with virtual CPU 242, virtual memory 245 and virtual hardware 248 instead of with physical CPU 100, memory 110 and hardware 120. Although Guest OS 260 may attempt to install a microcode update on virtual CPU 243 during its boot-up sequence, that update will not immediately be sent to any of the physical CPUs 100, 100a, 100b or 100c. Instead, according to an embodiment of the invention, VMM 240 will trap the instruction that is to install the microcode update and store the data containing the update for future use. Execution control can return to the instruction sequence of Guest OS 260, with flags or other indicators set to cause the OS to proceed as if the microcode update had succeeded. Similarly, Guest OS 260 may attempt to send a firmware update to one of the virtual (emulated) hardware devices 248. These virtual devices may or may not correspond to any of the physical hardware devices 120 installed in the machine. An embodiment of the invention will trap the guest OS's attempt to update the firmware and store the update; if the firmware is appropriate for an actual hardware device, it may be installed at some later time.

There are several reasons why installing processor microcode updates from software such as VMM application 160 of FIG. 1 or Guest OS 260 of FIG. 2 is inadvisable, and in some cases impossible. First, as mentioned earlier, it is preferable to install a microcode update as soon as possible after power-up or reset processing. Otherwise, software may detect the capabilities of the unpatched processor and, relying on those capabilities, may malfunction when updated microcode changes the processor's characteristics. Second, VMM software may not cause the virtual CPU to identify itself in the same way as the physical CPU. For example, the virtual CPU may report that it is a different model, or that it has different characteristics or capabilities, than the physical CPU. Therefore, software running under the VMM may not be able to select an appropriate microcode update to install. Third, the physical system may include several processors, but the VMM may only report a single virtual CPU to software running on the virtual machine. Multiprocessor systems may not operate consistently if individual processors have been patched with different microcode updates. Worse, a VMM may distribute the work of executing virtual machine software among the processors, so if the processors have different microcode installed, an application running on the virtual machine may find that the characteristics of the processor change inexplicably from time to time. For at least these reasons, software running on a virtual CPU should not be permitted to patch the underlying physical CPU directly, without reviewing the state of the physical system and software executing there to ensure that no programs would be adversely affected by the microcode change.

Similar reasons make it inadvisable or impossible to install firmware updates for hardware devices from a VMM application or guest OS directly into physical hardware present in a system. The VMM may emulate some or all of the hardware accessible to the guest OS; the system may not actually contain some of the devices the guest OS believes are present, and may contain different models or versions of other devices. Therefore, software running under the VMM may not be able to select useful firmware updates to install, and may be unaware of other software that is also using the hardware. Embodiments of the invention may also trap attempts to install firmware updates into virtual or emulated hardware devices, and save the updated firmware for (possible) later installation.

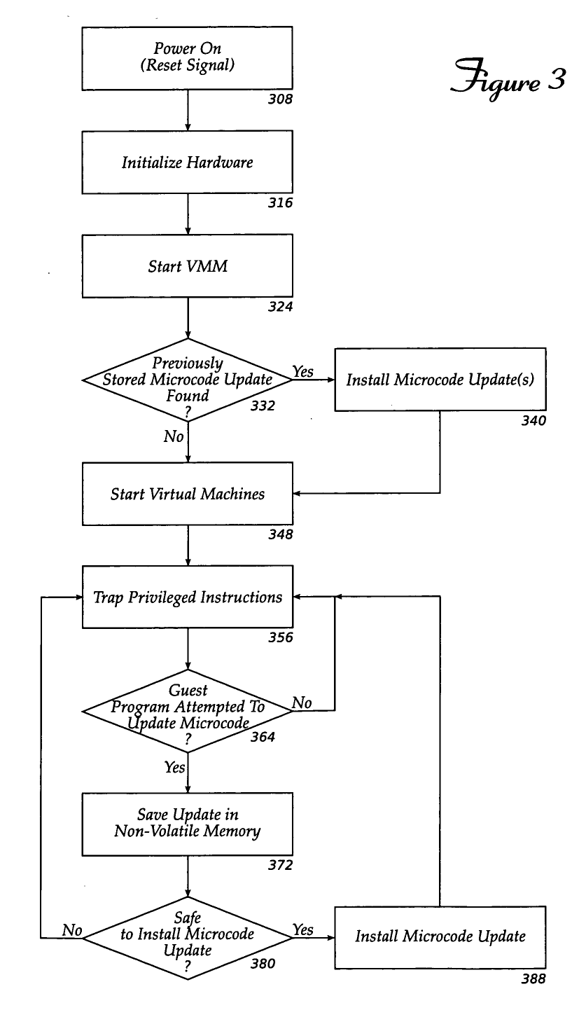

FIG. 3 is a flow chart showing operations of a virtual machine monitor according to an embodiment of the invention. When the physical hardware is powered on (or when it receives a hard reset signal) (308), a BIOS will initialize the hardware (316) and start the VMM (324). The VMM will check for previously-saved microcode updates in a non-volatile storage area (332) and, if found, install them on all appropriate physical processors and/or physical devices (340).

Next, the VMM will start one or more virtual machines (348), and each will operate largely indistinguishably from a physical machine that had just been turned on or reset. For example, a virtual BIOS might initialize virtual hardware and load a guest OS from an emulated disk.

As the virtual machines execute, certain privileged instructions that could alter the state of a physical CPU or physical hardware are trapped (356), and VMM routines are invoked to determine how to emulate the privileged instructions. If a guest program has attempted to update the microcode of a virtual CPU or emulated device (364), the VMM saves the microcode update in non-volatile storage (372) and determines whether the update can be safely installed (380). If so, the update may be installed immediately (388); otherwise, it will remain in non-volatile storage until the next time the VMM is started.

As mentioned above, the physical machine on which a VMM executes may include multiple physical CPUs. The virtual machine that is presented to guest software may appear to have a different number of CPUs—either more or fewer CPUs than actually exist in the physical machine. Each physical CPU may contain two or more execution cores, each of which may be essentially an independent CPU, although certain circuitry may be shared between cores. VMMs incorporating embodiments of the invention may manage all the CPUs and execution cores of a physical machine, and may install saved microcode updates at system start-up or at other times when the VMM determines that changing CPU characteristics is “safe” (e.g. that it would not adversely affect guest software or the VMM itself).

Similarly, the physical machine may contain different hardware devices than those that appear to be available to guest software. VMMs incorporating embodiments of the invention may manage the physical devices, collect firmware updates that guest software attempts to install, and install appropriate updates on physical devices at system start-up or at other times when the VMM determines that the devices are idle and that the updates would not adversely affect guest software or the VMM.

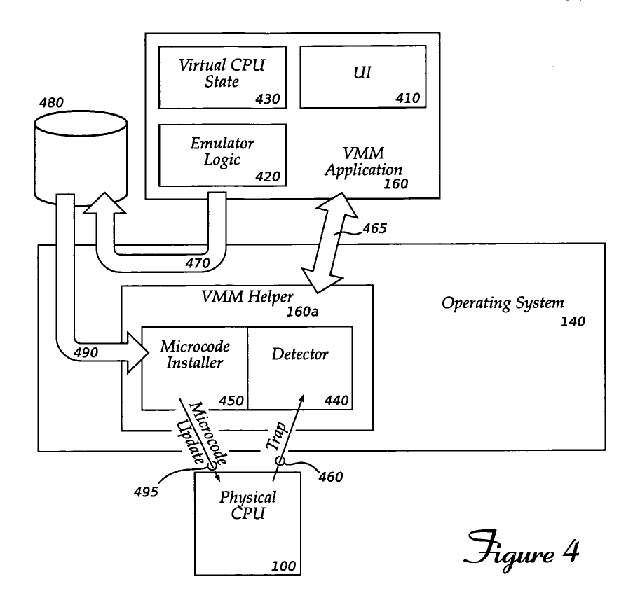

FIG. 4 shows a detailed block view of an OS-hosted VMM application that implements an embodiment of the invention. Here, “OS-hosted” means that the VMM application runs under the control of a host operating system, and may not have full and exclusive access to the physical CPU 100, or to memory or other physical devices (not shown). This VMM application may be similar in structure and operation to the one shown as elements 160 and 160a of FIG. 1.

VMM Application 160 may include a number of subroutines or functional units, including a user interface (“UI”) 410, emulator logic 420 to emulate some of the machine instructions of a virtual CPU, and data to represent the state of a virtual CPU, 430. This embodiment also includes VMM Helper 160a, which may be embedded in host operating system 140 as a device driver, kernel module or similar software entity. The helper's location within the operating system may permit the VMM system (including VMM application 160 and helper 160a) to obtain privileged information about the system's state and/cr to perform privileged operations directly on the underlying hardware.

VMM Helper 160a may include detector 440 to detect when an unprivileged instruction stream attempts to execute a privileged instruction, and microcode installer 450 to install a microcode update into physical CPU 100.

The system shown in FIG. 4 might perform some or all of the following sequence of operations. While executing an instruction stream contained in a memory (not shown), CPU 100 encounters a privileged instruction to update the CPU's microcode. Instead of performing the update, the CPU issues a trap 460 (also called an interrupt or exception) which is directed to detector 440. VMM helper 160a notifies VMM application 160 of the trap through a communication channel 465. Emulator logic 420 examines the state of the virtual CPU 430 and stores the microcode update that was to be loaded by the trapped instruction in non-volatile storage. As shown in this figure, VMM application 160 uses ordinary OS file facilities 470 to save the microcode update on disk 480. Later, microcode installer 450 in VMM helper 160a may retrieve the previously-stored update (490) from disk 480 and install it on the physical CPU (495). The microcode installation might occur long after the update was saved to disk 480, and might be done each time the physical system was reset or powered up, as part of the reset or power-up sequence, instead of just once. Alternatively, the VMM helper 160a could monitor the state of the system and delay the microcode installation until the helper determined that no software would be adversely affected by the installation.

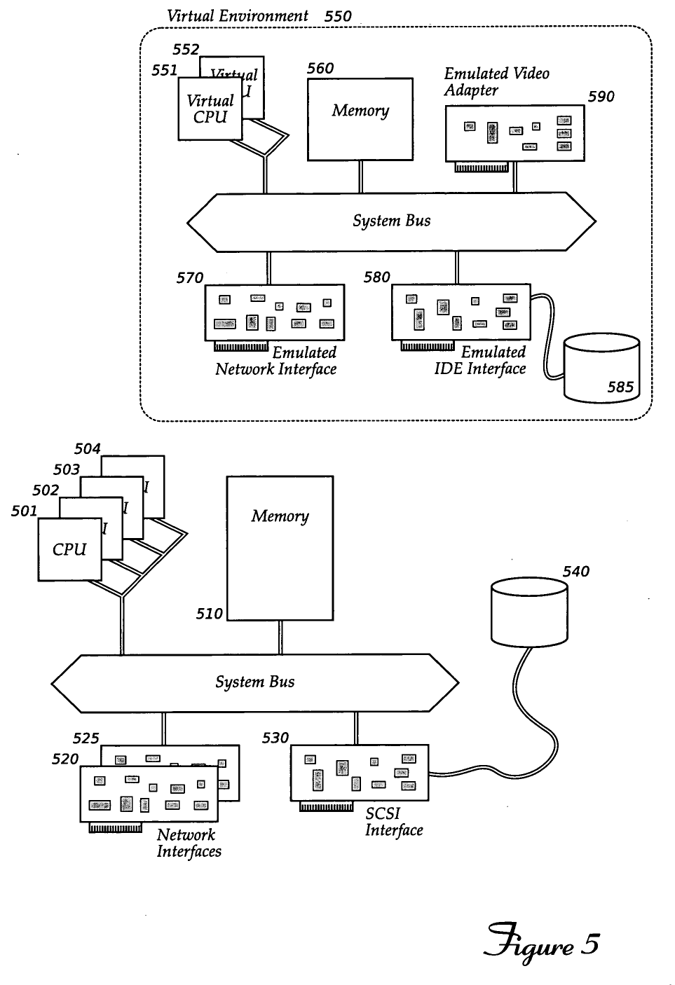

FIG. 5 shows a physical system on which an embodiment of the invention might operate. The system includes four CPUs 501-504, a physical memory 510, two network interfaces 520 and 525, and a Small Computer Systems Interface (“SCSI”) storage interface 530 to connect to hard disk 540. Inset 550 shows a virtual system that a VMM might present to guest software. Note that there are only two virtual CPUs 551 and 552, a different amount of memory 560, one emulated network interface 570, an emulated Integrated Device Electronics (“IDE”) storage interface 580 to connect to virtual disk 585, and an emulated video adapter 590. Clearly, guest software executing within the virtual environment 550 would encounter many difficulties in selecting and installing microcode and firmware updates that are appropriate for the actual, physical hardware. Embodiments of the invention permit unaltered guest software to execute normally (including possible attempts to install processor microcode or device firmware), while protecting the integrity of the physical system and other virtual operating environments executing on the same system.

Some physical processors implement an architecture that is designed to support efficient virtualization. VMMs that execute on such processors may only need to provide a “thin” layer of software functionality to emulate one or more virtual machines that seem to be independent physical systems. A VMM for a processor of this sort might be able to permit one or more of the physical processors to execute most guest software instructions directly (and at full speed). The VMM's chief task might be to emulate certain instructions that are to change the operational configuration of a processor. Common operational configuration settings that may be protected in a virtual machine include physical-to-virtual memory mapping registers and memory protection registers, interrupt tables and, of relevance to embodiments of the current invention, processor microcode. Processors that are designed to support efficient virtualization may provide a mechanism to automatically detect and intercept (“trap”) configuration-changing instructions. When such instructions are intercepted, the VMM can examine the state of the virtual CPU, determine what configuration change the guest software was attempting, and emulate the change by altering the state of the virtual CPU in a way that avoids affecting other, unrelated guest software.

Processors implementing one or more of Intel Corporation's IA-32 architecture and the later, backwards-compatible Itanium® architecture contain features to support efficient virtualization. For example, these processors recognize several different privilege levels, and prevent software executing at certain privilege levels from invoking certain configuration-changing instructions. In particular, the IA-32 architecture defines a machine instruction called Write to Model-Specific Register (its mnemonic is “WRMSR”), which (among other operations) permits software to install a microcode update into the processor. The WRMSR instruction is privileged, and the processor automatically traps it when it is encountered in an unprivileged instruction stream. The trap prevents the execution of the instruction and, instead, invokes privileged code that may take some other action. For example, an embodiment of the invention may save the microcode update in non-volatile memory for later use. In one embodiment, the microcode update may be written on a mass storage device such as a hard disk. In another embodiment, the microcode update may be analyzed to determine whether it is applicable to the physical CPUs, and discarded if it is not.

An embodiment of the invention may be a machine-readable medium having stored thereon instructions which cause a system containing one or more physical processors to perform operations as described above. In other embodiments, the operations might be performed by specific hardware components that contain hardwired logic. Those operations might alternatively be performed by any combination of programmed computer components and custom hardware components.

A machine-readable medium may include any mechanism for storing or transmitting information in a form readable by a machine (e.g., a computer), including but not limited to Compact Disc Read-Only Memory (CD-ROMs), Read-Only Memory (ROMs), Random Access Memory (RAM), Erasable Programmable Read-Only Memory (EPROM), and a transmission over the Internet.

The applications of the present invention have been described largely by reference to specific examples and in terms of particular allocations of functionality to certain hardware and/or software components. However, those of skill in the art will recognize that microcode updates can also be performed by virtual machine monitor software and hardware that distribute the functions of embodiments of this invention differently than herein described. Such variations and implementations are understood to be apprehended according to the following claims.

I claim:

1. A method comprising:
trapping an instruction to change a microcode update or microcode program of a virtual device;
saving a microcode update or microcode program associated with the trapped instruction; and
installing the microcode update or microcode program on one or more non-virtual computer devices.

2. The method of claim 1 wherein the virtual device is a virtual computer processor and the one or more non-virtual computer devices are non-virtual computer processors.

3. The method of claim 2 further comprising:
emulating a plurality of machine instructions of the virtual computer processor.

4. The method of claim 3 wherein emulating a plurality of machine instructions comprises:
executing a first group of the plurality of machine instructions directly on one of the one or more non-virtual processors; and
adjusting a state of the virtual processor in response to instructions of a second group of the plurality of machine instructions.

5. The method of claim 2 wherein the virtual computer processor implements at least one of an Intel® IA-32 architecture or an Intel® Itanium® architecture.

6. The method of claim 2 wherein the one or more non-virtual computer processors implement at least one of an Intel® IA-32 architecture or an Intel® Itanium® architecture.

7. The method of claim 1 wherein the virtual device is one of a network interface, a mass storage interface or a video interface.

8. The method of claim 1, wherein saving the microcode update or microcode program comprises storing it in a non-volatile memory.

9. The method of claim 1, wherein saving the microcode update or microcode program comprises writing it to a mass storage device.

10. The method of claim 1 further comprising:
analyzing the microcode update or microcode program to determine whether it is applicable to the one or more non-virtual devices.

11. A virtual machine manager comprising:
an emulator to emulate a plurality of machine instructions;
a detector to detect an attempt to update a microcode of a virtual device;
a storage to record a microcode update; and
an installer to install a recorded microcode update.

12. The virtual machine manager of claim 11 wherein the virtual device is a virtual processor.

13. The virtual machine manager of claim 12, wherein the emulator is to emulate a physical processor that implements at least one of an Intel® IA-32 architecture or an Intel® Itanium® architecture.

14. The virtual machine manager of claim 11, wherein the installer is to install the recorded microcode update on at least one physical processor.

15. A system comprising:
at least one physical processor to emulate a machine containing at least one virtual processor and at least one virtual device and to trap a privileged instruction;
a memory; and
a non-volatile storage system to store a microcode update; wherein
the privileged instruction is to update a microcode of one of the at least one virtual processor or the at least one virtual device.

16. The system of claim 15, further comprising:
at least one physical device; and
a microcode installer to install the microcode update on one of the at least one physical processor and the at least one physical device.

17. The system of claim 15 wherein a type of the at least one virtual processor is identical to a type of the plurality of physical processors.

18. The system of claim 15 wherein the at least one virtual processor implements at least one of an Intel® IA-32 architecture or an Intel® Itanium® architecture.

19. The system of claim 15 wherein each of the plurality of physical processors implements at least one of an Intel® IA-32 architecture or an Intel® Itanium® architecture.

20. The system of claim 15 wherein the privileged instruction to update the microcode is Write to Mode-Specific Register (“WRMSR”).

21. The system of claim 15 wherein the at least one virtual device is one of a network interface, a mass storage interface, or a video interface.

22. A machine-readable medium containing instructions that, when executed by a physical processor, cause the physical processor to perform operations comprising:
emulating a computer system containing a processor and at least one device;
trapping an instruction to update a microcode of the emulated processor or the at least one device;
storing an updated microcode to be installed by the instruction; and
installing the updated microcode.

23. The machine-readable medium of claim 22, containing additional instructions to cause the physical processor to perform operations comprising:
installing the updated microcode if the processor executes one of a reset sequence or a power-on sequence.

24. The machine-readable medium of claim 22, containing additional instructions to cause the physical processor to perform operations comprising:
monitoring a state of the physical processor; and
delaying the installing operation until the physical processor or device is in a predetermined state.

25. The machine-readable medium of claim 22 wherein the virtual processor implements at least one of an Intel® IA-32 architecture or an Intel® Itanium® architecture.
